(19) United States
(12) Patent Application Publication
(10) Pub. No.: US 2005/0212770 A1
(43) Pub. Date: Sep. 29, 2005

(54) Wireless mouse device free of battery

(76) Inventors: Rung-Tsung Lin, Taipei Hsien (TW); Ding-Kan Chang, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/807,154

(22) Filed: Mar. 24, 2004

(51) Int. Cl. G09G 5/08

(52) U.S. Cl. 345/163

(57) ABSTRACT

The wireless mouse device free of a battery of the present invention is integrated to have a power processing circuit and a sensing coil. A receiver unit for receiving the signals of the mouse is integrated to have therein an alternative signal circuit and an emitting/receiving coil, so that the receiver unit can generate high frequency signals emitted via an emitting/receiving coil; the mouse can receive harmonic vibrations of the high frequency signals through the sensing coil, and the power processing circuit will make pressure-multiplication processing for the harmonic vibrations received to make the latter an electric power for driving the mouse.

### BACKGROUND OF THE INVENTION

1. Field of the Invention

The present invention is related to improvement of a wireless mouse used for notebooks, desk computers etc., and especially to a wireless mouse driving device without adding a battery.

2. Description of the Prior Art

Wireless mice generally used on PC's, notebooks or the so-called mobile computers are emphasized in having their functions without wires, the functions develop by RF signal transmission between a wireless mouse and a receiver unit, the receiver unit is further mounted on a peripheral device of or in the mainframe of a computer to obtain electric power nearby, and to connect with the electric circuit of the main board of the computer. Thereby, the mouse must have a battery to drive the circuit in the mouse to send out the signals of the positions of the mouse after moving, and the signals are received by the receiver unit and transmitted to the computer.

However, such a design renders the electric power source of the mouse limited to the battery. A user is unable to assure when the power of the mouse is to be exhausted, this will make the computer interrupt in use because of the insufficiency or sudden exhaustion of the power of the battery of the mouse, and even the normal execution of the computer system will be affected.

And more, using of the mouse mainly is to make convenient of the user in moving a cursor on a screen, agility of moving of the mouse will directly affect the accuracy of signals, thereby a mouse generally is placed on a plane article so-called as a “mouse pad” to render the mouse to get better agility during movement. The function of the “mouse pad” surely is important, however, its main structure can not effectively be integrated with the hardware of the computer, it may be neglected and not be applied in using, thus the operation quality of the mouse is reduced.

### SUMMARY OF THE INVENTION

The wireless mouse device free of a battery of the present invention is integrated to have a power processing circuit and a sensing coil in addition to having therein a basic signal generating circuit. The receiver unit for receiving the signals of the mouse is integrated to have therein an alternative signal circuit and a signal processing circuit, the electric power connected with the receiver unit can generate high frequency signals emitted via an emitting/receiving coil in addition to drive the internal circuits; the mouse can receive the harmonic vibrations of the high frequency signals through the sensing coil, and the power processing circuit will make pressure-multiplication processing for the harmonic vibrations received to make the latter an electric power of the internal circuits for driving the mouse, this forms the normal operation mode of the mouse without adding a battery.

Certainly, the receiver unit can also be designed as a style of a mouse pad directly for sliding of the mouse to save the space that a receiver unit may extraordinarily occupy.

The operation mode between the mouse and the receiver unit can be changed to the operation mode between keyboard and the receiver unit, so that the keyboard used for a PC also has its functions without a wire nor a battery; otherwise, the operation mode between the mouse and the receiver unit can be combined with the operation mode between the keyboard and the receiver unit, so that the receiver unit can be used for both signal transmission of the mouse and the keyboard, and the mouse as well as the keyboard both have their functions without wires nor batteries.

And even the mouse pad can be allocated in a lower layer of a notebook or the keyboard, so that the mouse pad can be received normally in the lower layer of the notebook or the keyboard, when in use, the mouse pad can be taken out of the notebook or the keyboard for use, this can largely increase the practicality and convenience of use of the entire mouse device.

The present invention will be apparent in its structural combination as well as entire operation mode after reading the detailed description of the preferred embodiment thereof in reference to the accompanying drawings.

### BRIEF DESCRIPTION OF THE DRAWINGS

FIGS. 1 is a schematic view showing the basic members composing the present invention;

FIGS. 2 is a block diagram showing the internal elements of a mouse and a receiver unit in a first embodiment of the present invention;

FIG. 3 is a schematic view showing the state of practicing of a second embodiment of the present invention;

FIG. 4 is a schematic view showing the state of practicing of a third embodiment of the present invention;

FIG. 5 is a schematic view showing the state of practicing of a fourth embodiment of the present invention;

FIG. 6 is a schematic view showing the state of practicing of a fifth embodiment of the present invention;

FIGS. 7 is a schematic view showing the state of practicing of a sixth embodiment of the present invention;

FIG. 8 is a schematic view showing arrangement of a mouse pad of a seventh embodiment of the present invention;

FIG. 9 is a schematic view showing accommodation for the mouse pad of the seventh embodiment of the present invention;

FIG. 10 is a schematic view showing allocation of a mouse pad of an eighth embodiment of the present invention;

FIG. 11 is a schematic view showing allocation of a mouse pad of a ninth embodiment of the present invention;

FIG. 12 is a schematic view showing allocation of a mouse pad of a tenth embodiment of the present invention.

### DETAILED DESCRIPTION OF THE PREFERRED EMBODIMENT

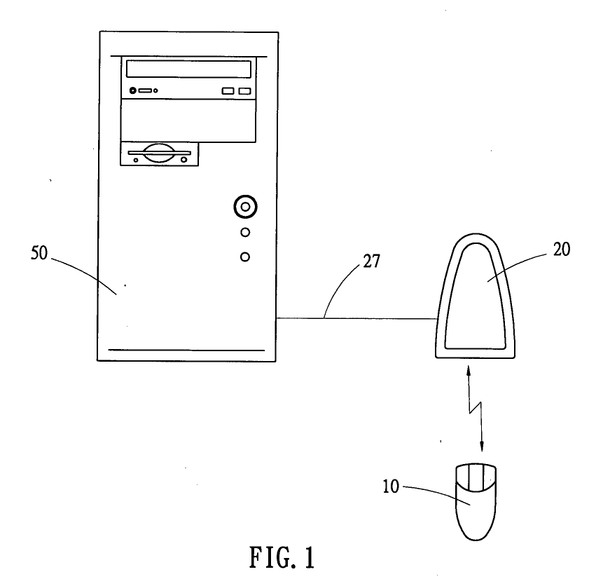

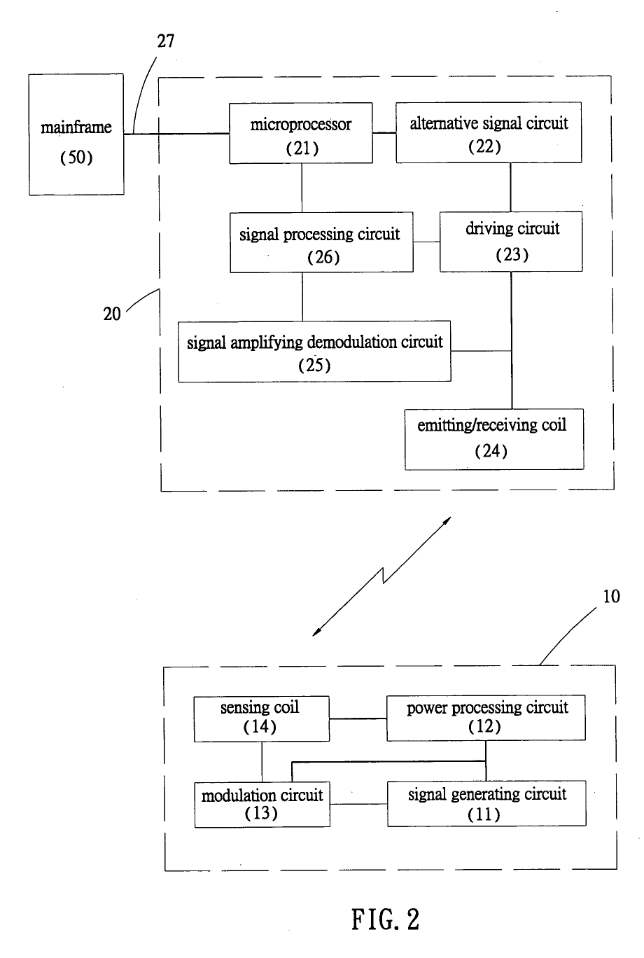

FIGS. 1 and 2 show the components of the wireless mouse device free of a battery of the present invention, including: a mouse 10 being integrated to have a power processing circuit 12, a modulation circuit 13 and a sensing coil 14 in addition to having therein a basic signal generating circuit 11; a receiver unit 20 for transmitting signals between the mouse 10 and a mainframe 50, a signal line 27 is directly connected with the mainframe 50, the receiver unit 20 is integrated to have therein a microprocessor 21, an alternative signal circuit 22, a driving circuit 23, an emitting/receiving coil 24, a signal amplifying demodulation circuit 25 and a signal processing circuit 26.

Referring simultaneously to FIGS. 1 and 2, when the mainframe 50 is activated, the receiver unit 20 can directly obtain the electric power from the mainframe 50 via the signal line 27 to drive its internal circuits, the alternative signal circuit 22 changes the electric power into high frequency signals, and the emitting/receiving coil 24 emits the signals in the RF mode. The mouse 10 receives harmonic vibrations of the high frequency signals through the sensing coil 14; and the power processing circuit 12 will make pressure-multiplication processing for the harmonic vibrations received to make the latter an electric power of the internal circuits for driving the mouse 10, this forms the operation mode of the mouse 10 without adding a battery for driving.

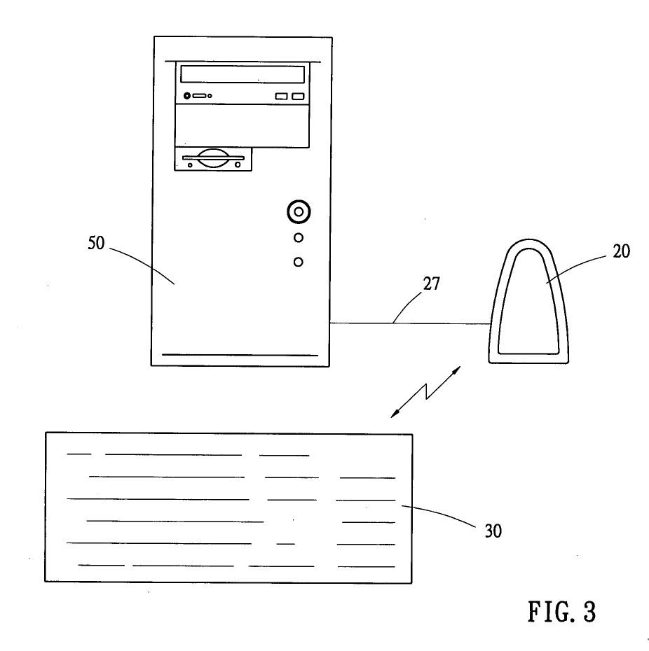

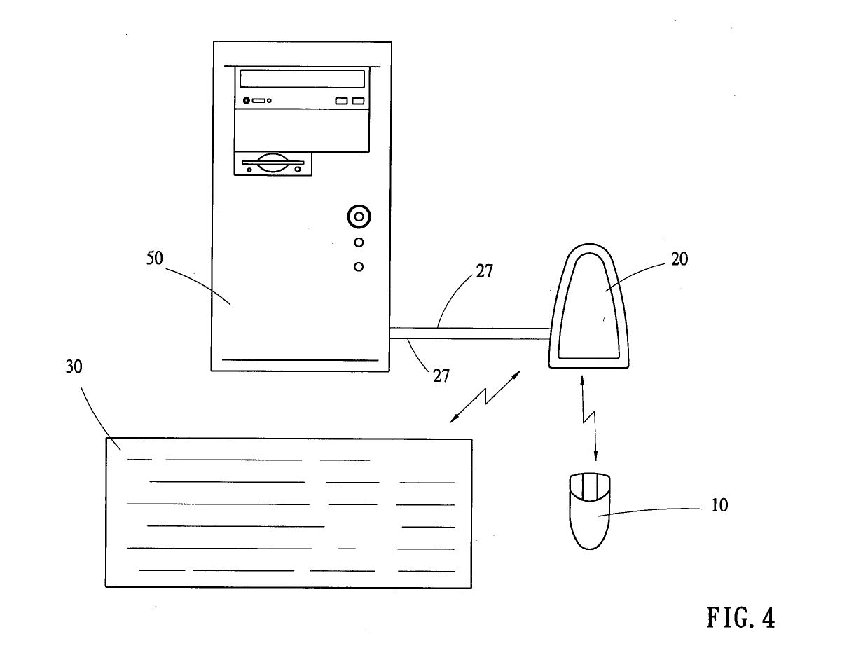

Surely, the wireless operation mode between the mouse 10 and the receiver unit 20 can be changed to the operation mode between keyboard 30 and the receiver unit 20 (as shown in FIG. 3), so that the keyboard 30 used for a PC also has its functions without a wire nor a battery; or as shown in FIG. 4, the operation mode between the mouse 10 and the receiver unit 20 can be combined with the operation mode between the keyboard 30 and the receiver unit 20, so that the receiver unit can be used for both signal transmission of the mouse 10 and the keyboard 30, and the mouse 10 and the keyboard 30 both have their functions without wires nor batteries.

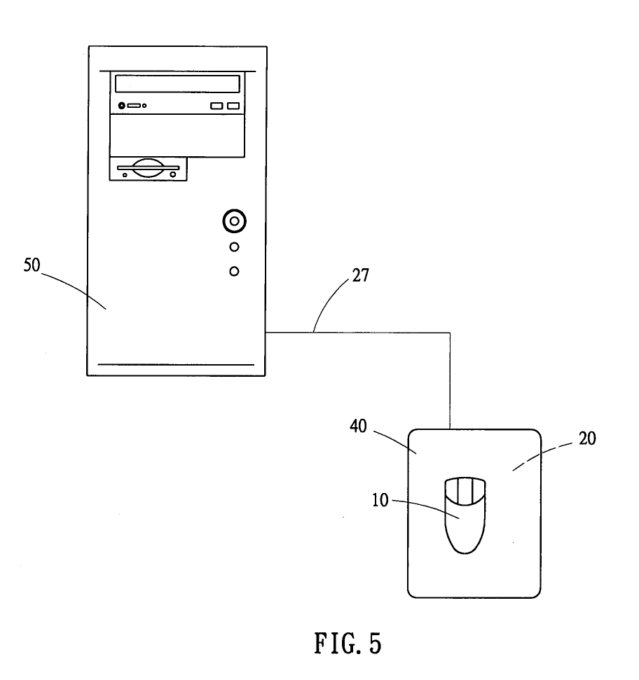

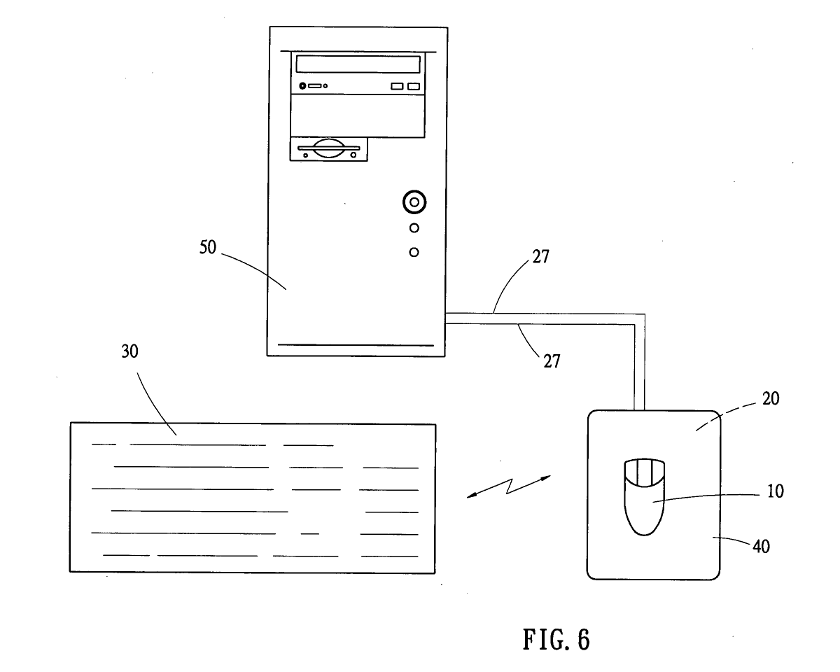

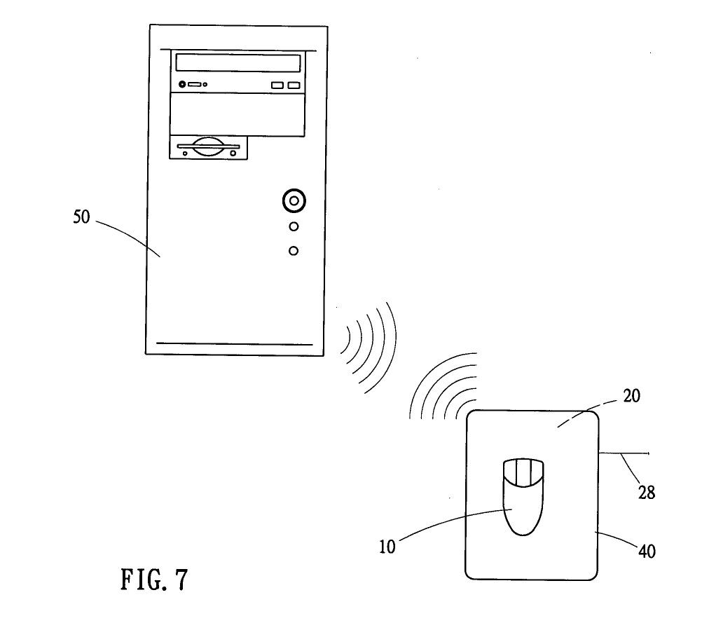

Especially, as shown in FIG. 5, the receiver unit 20 can also be designed as a style of a mouse pad 40 directly for sliding of the mouse 10 thereon to save the space that the receiver unit 20 may extraordinarily occupy. And as shown in FIG. 6, when the operation mode between the mouse 10 and the receiver unit 20 is combined with the operation mode between the keyboard 30 and the receiver unit 20, the mouse 10 and the keyboard 30 can perform simultaneously signal transmission with the mainframe 50 by means of the receiver unit 20 provided in the mouse pad 40. Certainly, the receiver unit 20 itself can obtain power supplying not from the mainframe 50, as shown in FIG. 7, the receiver unit 20 can obtain power supplying via a power line 28 and only do wireless signal transmission with the mainframe 50.

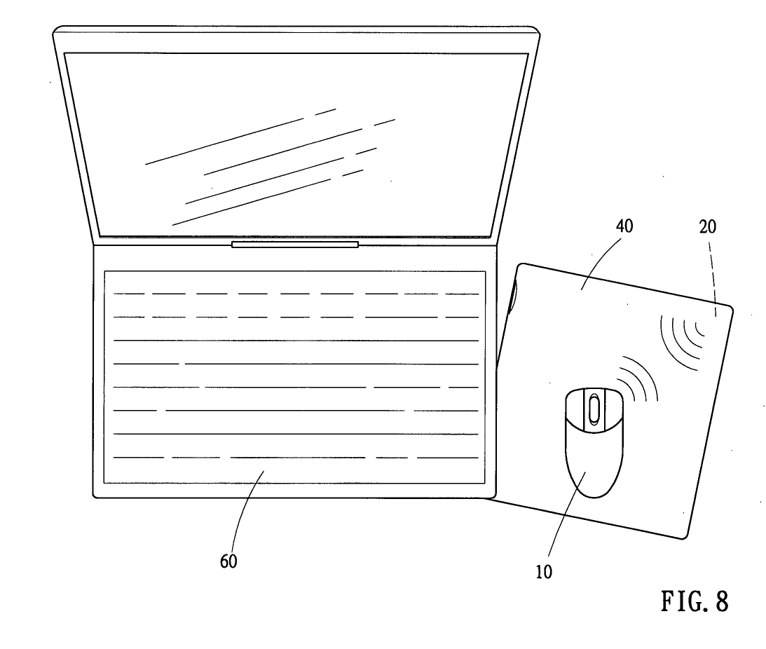

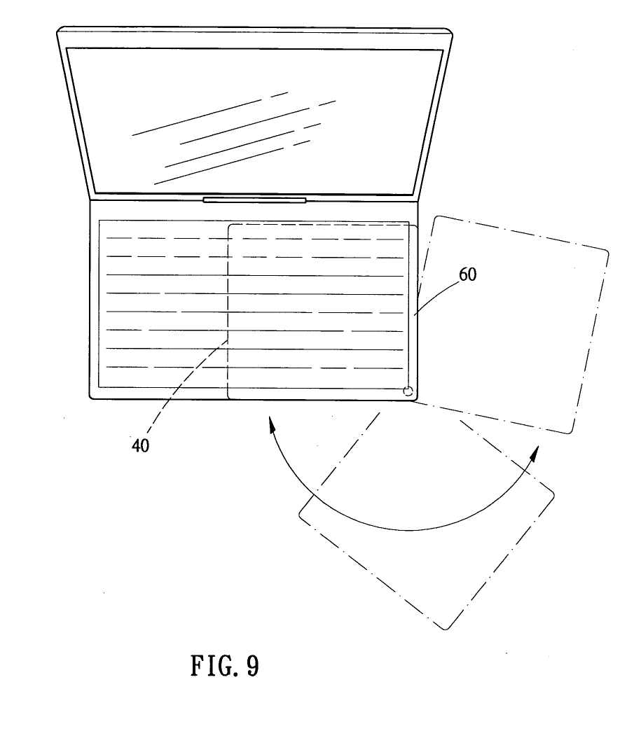

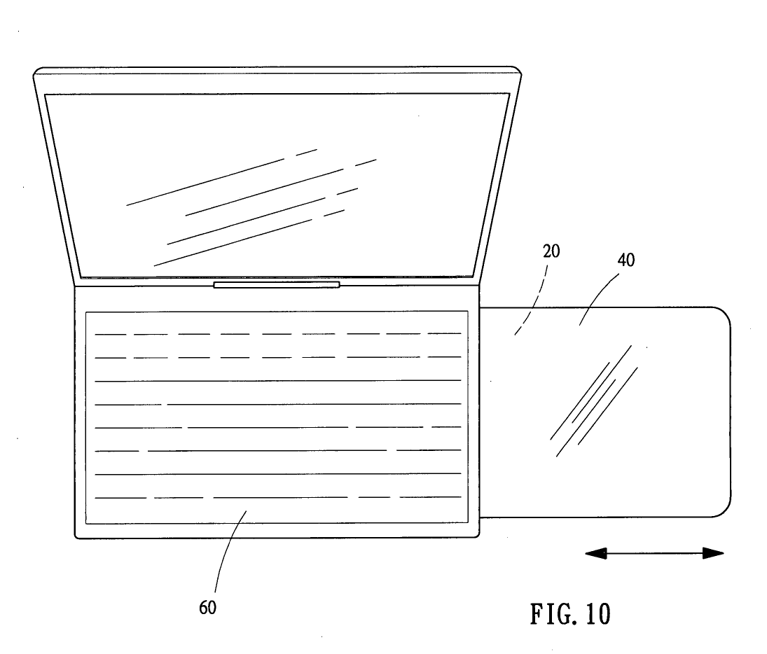

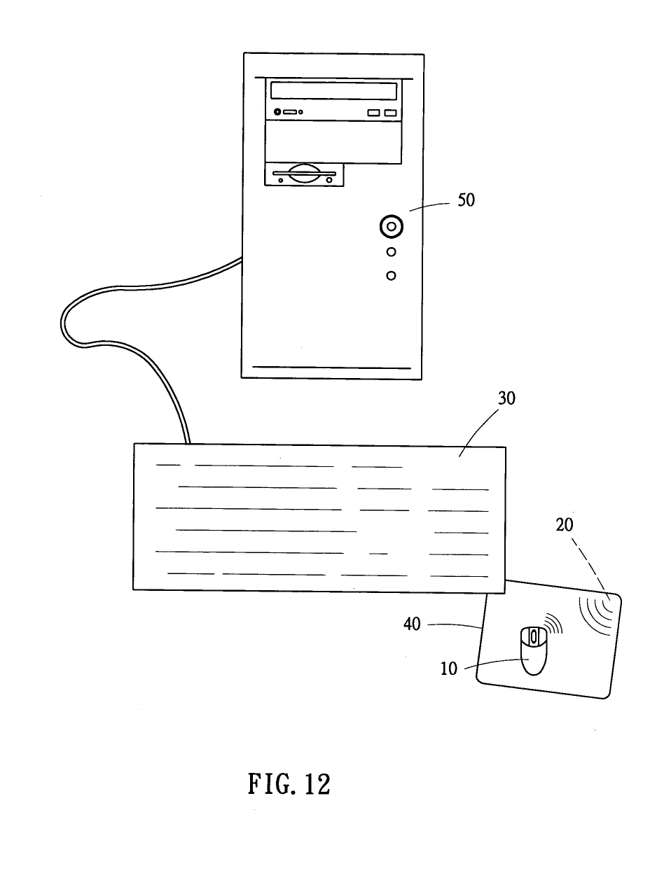

And even as shown in FIGS. 8 and 12, the mouse pad 40 can be allocated in a lower layer of a notebook 60 or the keyboard 30, so that the mouse pad 40 can be received normally in the lower layer of the notebook 60 or the keyboard 30, when in use, the mouse pad 40 can be taken out of the notebook 60 or the keyboard 30 for use, this can largely increase the practicality and convenience of use of the entire mouse device. Wherein, the mouse pad 40 can be a sheet like structural member for placing thereon the mouse 10, it is pivotally provided in the lower layer of the notebook 60 as shown in FIGS. 8 and 9, or is slipped in the lower layer of the notebook 60 as shown in FIG. 10, it can thus be accommodated in the lower layer of the notebook 60 (as shown in FIG. 9), or can be drawn out of the lower layer of the notebook 60 for placing the mouse pad 40 thereon.

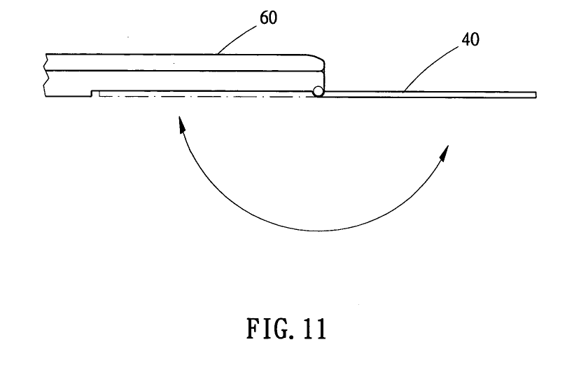

Certainly, the mouse pad 40 can be pivotally provided in the lower layer of the notebook 60 by way of folding and lifting, such as is shown in FIG. 11, this also renders the function of accommodating the mouse pad 40 convenient, and can effectively integrate the hardware including the mouse pad, the notebook, the mobile computer or the externally connected keyboard etc. in order to extend the scope of application of the entire mouse device to a desk computer, a notebook or a so-called mobile computer to increase convenience of the mouse device.

The mouse pad 40 can be connected with the notebook 60 directly as shown in FIG. 8, or connected with the mainframe 50 of the desk computer through the keyboard 30 as shown in FIG. 12; and the receiver unit 20 is provided in the mouse pad 40 for receiving RF signals from the mouse 10, thereby signal transmission and connection between the mouse 10 and the notebook 60 (as shown in FIG. 8) or between the mouse 10 and the mainframe 50 of the desk computer (as shown in FIG. 12) is achieved. And by virtue that the mouse 10 receives the harmonic vibrations of high frequency signals to make the latter an electric power of the internal circuits for driving the mouse 10, the problem that the electric power of the mouse 10 is insufficient or suddenly exhausted during operation of the computer to result interruption of the computer or even to affect the normal execution of the computer system can be effectively solved.

As state above, the present invention provides a better practicable wireless mouse, however, the specification and the drawings are only for illustrating a preferred embodiment of the present invention, and not for giving any limitation to the scope of the present invention. It will be apparent to those skilled in this art that various equivalent modifications or changes without departing from the spirit of this invention shall fall within the scope of the appended claims.

1. A wireless mouse device free of a battery comprising:
a mouse having therein a signal generating circuit to form signals of commands of said mouse, and being integrated to have a power processing circuit and a sensing coil;
a receiver unit connected with a mainframe of a computer, and being integrated to have therein a microprocessor, an alternative signal circuit, an emitting/receiving coil, and being provided for receiving RF signals from said mouse;
so that when said mainframe of said computer is activated, said receiver unit generates high frequency signals through said alternative signal circuit, and said emitting/receiving coil emits said signals, said mouse receives harmonic vibrations of said high frequency signals through said sensing coil, and said power processing circuit makes pressure-multiplication processing for said harmonic vibrations received to make said harmonic vibrations an electric power of internal circuits for driving said mouse.

2. The wireless mouse device free of a battery as in claim 1, wherein: said mouse further has a modulation circuit, said receiver unit further has a driving circuit, a signal amplifying demodulation circuit and a signal processing circuit to make integration and transmitting of signals.

3. The wireless mouse device free of a battery as in claim 1, wherein: the operation mode between said mouse and said receiver unit is adapted to changing to the operation mode between a keyboard and said receiver unit.

4. The wireless mouse device free of a battery as in claim 1, wherein: the operation mode between said mouse and said receiver unit is combined with the operation mode between a keyboard and said receiver unit, so that said receiver unit is used for both signal transmission of said mouse and said keyboard.

5. The wireless mouse device free of a battery as in claim 1, wherein: said receiver unit is designed as a style of a mouse pad directly for sliding of said mouse.

6. The wireless mouse device free of a battery as in claim 4, wherein: said receiver unit is designed as a style of a mouse pad directly for sliding of said mouse.

7. The wireless mouse device free of a battery as in claim 1, wherein: said receiver unit is connected with said mainframe through a signal line, said signal line directly obtain electric power from said mainframe for transmitting signals.

8. The wireless mouse device free of a battery as in claim 1, wherein: said receiver unit obtains electric power through an electric power line.

9. A wireless mouse device free of a battery comprising a mouse pad and a mouse for RF signal transmission, wherein:
said mouse pad is for placing thereon a mouse, it is connected with circuits of a notebook and is provided in a lower layer of said notebook to be pivotally rotated for accommodating or drawn out; said mouse pad is provided with a receiver unit which further includes therein a microprocessor, an alternative signal circuit and an emitting/receiving coil for receiving RF signals from said mouse, thereby signal transmission and connection between said mouse and said notebook is achieved, and said receiver unit generates high frequency signals through said alternative signal circuit, and said emitting/receiving coil emits said signals;
said mouse is integrated to have a signal generating circuit, a power processing circuit and a sensing coil; said signal generating circuit forms signals of commands of said mouse, said sensing coil receives harmonic vibrations of said high frequency signals, and said power processing circuit makes pressure-multiplication processing for said harmonic vibrations received to make said harmonic vibrations an electric power of internal circuits for driving said mouse.

10. The wireless mouse device free of a battery as in claim 9, wherein: said mouse further has a modulation circuit, said receiver unit further has a driving circuit, a signal amplifying demodulation circuit and a signal processing circuit to make integration and transmitting of signals.

11. A wireless mouse device free of a battery comprising: a mouse pad and a mouse for RF signal transmission, wherein:
said mouse pad is for placing thereon a mouse, it is connected with circuits of a keyboard of a mainframe of a desk computer and is provided in a lower layer of said keyboard to be pivotally rotated for accommodating or drawn out; said mouse pad is provided with a receiver unit which further includes therein a microprocessor, an alternative signal circuit and an emitting/receiving coil for receiving RF signals from said mouse, thereby signal transmission and connection between said mouse and said mainframe of a desk computer through said keyboard is achieved, and said receiver unit generates high frequency signals through said alternative signal circuit, and said emitting/receiving coil emits said signals;
said mouse is integrated to have a signal generating circuit, a power processing circuit and a sensing coil; said signal generating circuit forms signals of commands of said mouse, said sensing coil receives harmonic vibrations of said high frequency signals, and said power processing circuit makes pressure-multiplication processing for said harmonic vibrations received to make said harmonic vibrations an electric power of internal circuits for driving said mouse.

12. The wireless mouse device free of a battery as in claim 11, wherein: said mouse further has a modulation circuit, said receiver unit further has a driving circuit, a signal amplifying demodulation circuit and a signal processing circuit to make integration and transmitting of signals.
